(19) United States
(12) Patent Application Publication
(10) Pub. No.: US 2011/0084967 A1
(43) Pub. Date: Apr. 14, 2011

(54) Visualization of Datasets

(75) Inventors: Wim De Pauw, Scarborough, NY (US); Bernice Ellen Rogowitz, Ossining, NY (US)

(73) Assignee: International Business Machines Corporation, Armonk, NY (US)

(21) Appl. No.: 12/576,505

(22) Filed: Oct. 9, 2009

(51) Int. Cl. G06T 11/20; G06K 9/00; G06F 3/048

(52) U.S. Cl. 345/440; 382/168; 715/830; 715/764; 715/810

(57) ABSTRACT

Methods and apparatus for visualizing a dataset are presented. For example, a method for visualizing a dataset includes identifying a first portion and at least a second portion of the dataset, forming a summary of the second portion of the dataset, and visualizing, on a display device, the first portion of the dataset and the summary of the second portion of the dataset. The summary is represented by one or more spatial shapes different from a spatial shape representative of the second portion before the formation of the summary. The identification of the first portion and the second portion, the formation of the summary, and the visualization of the first portion and the summary are implemented in accordance with a processor device associated with the display device.

### FIELD OF THE INVENTION

The present invention relates generally to visualization of datasets, and more particularly the invention relates to visualization of a portion of a dataset and visualization of a context of the portion of the dataset.

### BACKGROUND OF THE INVENTION

A variety of types of two dimensional (2D) visualizations or displays are useful for many applications. Maps may provide geographic and directional information. 2D data graphs convey relationships between variables having meaning to technology, business and everyday life. 2D visualizations are used in design of buildings and devices. 2D displays are also used in critical situations, such as the routing of emergency vehicles and in response to disasters. Satellites orbiting the earth provide us with multi-dimensional data that can be displayed as detailed 2D maps of extensive areas. The amount of data included with the maps and other visualizations may be very large and can be expected to increase over time as a consequence of developing sensor, web, storage and computing technologies.

Browsing and inspecting data (e.g., two, three or multi dimensional data) in 2D visual representations, such as maps and graphs, can be challenging especially when the amount of data is large. Inspecting a particular data element may require zooming in to a small portion of a total 2D space covered by the data, then using panning and scrolling to view surrounding information. Understanding a subset of the data, and gaining good insight into its context has been a difficult problem in visualization.

### SUMMARY OF THE INVENTION

Principles of the invention provide, for example, methods and apparatus for visualizing a dataset. For example, in accordance with one aspect of the invention, a method for visualizing a dataset is provided. The method includes identifying a first portion and at least a second portion of the dataset, forming a summary of the second portion of the dataset, and visualizing, on a display device, the first portion of the dataset and the summary of the second portion of the dataset. The summary is represented by one or more spatial shapes different from a spatial shape representative of the second portion before the formation of the summary. The identification of the first portion and the second portion, the formation of the summary, and the visualization of the first portion and the summary are implemented in accordance with a processor device associated with the display device.

In accordance with another embodiment of the invention, apparatus for visualizing a dataset is provided. The apparatus includes a memory and a processor coupled to the memory. The apparatus is operative or configured to perform the above method.

In accordance with another embodiment of the invention, a system for visualizing a dataset is provided. The system comprises modules for implementing the above method.

In accordance with one more embodiment of the invention, an article of manufacture for visualizing a dataset is provided. The article of manufacture tangibly embodies a computer readable program code which, when executed, causes the computer to carry out the above method for visualizing a dataset.

Aspects of the invention provide, for example, viewing a focused-upon portion of a dataset while also viewing contextual information about other data of the dataset that is outside of the focused-upon portion. Further aspects of the invention provide visual metadata for information beyond a viewing window (e.g., a focused-upon viewing window).

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram of a method for visualizing a dataset, according to an embodiment of the invention.

FIG. 2 illustrates a two-dimensional map, according to an embodiment of the invention.

FIG. 3 illustrates a scrolled map showing a portion of the map of FIG. 2, scrolled so that the western portion of North America is not in-view, according to an embodiment of the invention.

FIG. 4 illustrates a scrolled map showing a portion of the map of FIG. 2, scrolled so that the eastern most portions of the map of FIG. 2 are not in-view, according to an embodiment of the invention.

FIG. 5 shows a process flow sheet for visualization of processes, according to an embodiment of the invention.

FIG. 6 illustrates a scrolled process flow sheet showing a portion of the process flow sheet of FIG. 5 scrolled to show only one vertical segment, according to an embodiment of the invention.

FIG. 7 illustrates a statistical scatterplot, according to an embodiment of the invention.

FIG. 8 illustrates a magnified portion of the scatterplot of FIG. 7, showing an in-view visualization and a summary visualization, according to an embodiment of the invention.

FIG. 9 depicts a computer system that may be useful in implementing one or more aspects and/or elements of the invention.

### DETAILED DESCRIPTION OF THE INVENTION

Techniques of the present invention will be described herein in the context of illustrative methods for visualization of two-dimensional data. It is to be appreciated, however, that the techniques of the present invention are not limited to the specific method shown and described herein. Rather, embodiments of the invention are directed broadly to techniques for visualization and display of data, information or knowledge of any dimension. For this reason, numerous modifications can be made to the embodiments shown that are within the scope of the present invention. No limitations with respect to the specific embodiments described herein are intended or should be inferred.

The term summary, as used herein, may refer to a brief, concise or compressed representation of what is being summarized, for example, data that is being summarized. By way of example only, a summary may be a concise representation of all data within a dataset, or may be a concise representation of selected data from the dataset. For example, if a dataset comprises two groups of data, a summary may be a mathematical average of both groups of data together or a mathematical average of only one of the two groups of data. More generally, the term summary may refer to a representation of one or more particular aspects of a dataset or a representation of one or more particular aspects of a visualization of a dataset. For example, a particular aspect of a geographical map may be a location of a land mass. The corresponding summary may be an icon indicating the position of the land mass.

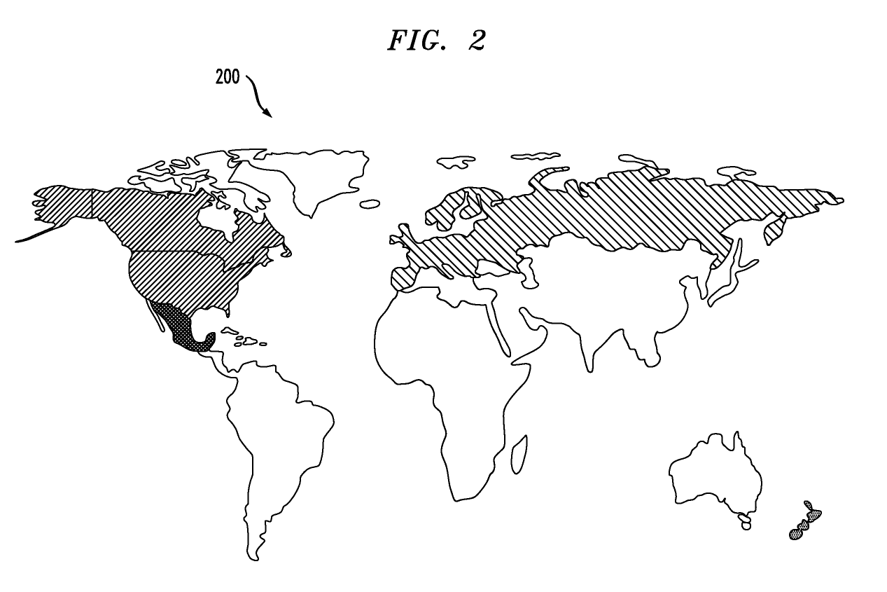

A dataset, as used herein, comprises data associated with a visualization, for example, the visualizations shown in FIGS. 2-8 and other visualizations of embodiments of the invention.

A visualization is a visual representation of information, data or knowledge. Visualizations include, but are not limited to, images such as, for example, images displayed in accordance with computing or processor devices, cellular phones and gaming devices. Visualizations may be dynamic in that the visualization may be updated periodically or continuously, or visualizations may be static in that the visualization is fixed. Examples of dynamic visualizations may include images associated with processor devices. Examples of static visualizations may include maps and images of information on paper, film or other media. Visualizations and images may be presented on display devices, for example, display devices associated with processor devices, cellular phones and gaming devices; paper; billboards and other public display devices.

Exemplary visualizations or images, according to certain embodiments of the invention comprise an in-view visualization or image and summary strips. The in-view visualization includes visualization (e.g., a view or views) of a map, data, information or knowledge. By way of example only, the in-view visualization may include data or information that is original, for example, not compressed or summarized for representation in the summary strips. The data or information in the in-view visualization may include, for example, data or information that could be direct information, such as a heat map showing population across the United States, or of processed information, such as a heat map of calculated income per capita, or a visualization that highlights only those zip codes with income per-capita above a certain value. The summary strips include visualizations or images of the map, data, information or knowledge that is currently outside of the in-view visualization (i.e., out of view information). The summary strips may include information, data or knowledge that is compressed, summarized or transformed (e.g., spatially, statistically or mathematical transformed). A summary strip may be, for example, a rectangular strip, a circular annulus surrounding a circular view of the data, or other geometric forms depending on the application.

Browsing and inspecting two dimensional (2D) data in visual representations can be challenging when the amount of data is large. Inspecting a particular data element may require zooming in to a small portion of a total 2D space covered by the data. While the data element under inspection may be visible at a deep zoom level, it becomes much harder for the user to see the context of this data element, especially when context involves more than just the area that is close to the element under inspection in Euclidean distance. For example, the user may want to keep the context of other elements that are close to the data element under inspection in just the x-direction or the y-direction, and may be interested in understanding how events far away in x and y influence the data element under analysis.

Techniques for visualizing 2D data include a graphical fish-eye and a zoom-panel. The graphical fish-eye distorts the data and does not work well for large amounts of data. The zoom-panel is a small image panel that only shows the spatial position of the zoomed upon viewpoint relative to the total 2D space. Both the fish-eye and zoom panel may show scaled down (e.g., smaller sized) visualizations of individual data items, for example, de-magnified portions of a map. The scaled down visualizations are otherwise similar to their respective original visualizations, that is, the scaled down visualizations do not characterize statistical, analytical, or summary data about the data outside the main view.

Exemplary features of the invention include techniques for displaying information (e.g., context information) which is out of range (i.e., out of view) of an in-view window. The out of view information for a scrolled 2D image, may be presented, for example, along the boundaries of the visualization in displayed summary strips, so that users can get efficient and quick insight into the information that is currently out of range of the in-view window. Information about features that are out of range to the top, bottom or sides of the in-view window may be displayed in these summary strips, which may be placed, for example, at or outside of the top, bottom and/or sides of the in-view window. As the user scrolls, moving attention to different parts of the representation (i.e., scrolling for different in-view visualizations), the information in the summary strips may be dynamically updated.

Visualizations of three dimensional data may also be presented according to embodiments of the invention. Summary strips may represent out of view portions of data for each dimension. More than three dimensions are also contemplated.

The summary strips may comprise, for example, abstractions, summaries (e.g., summary statistics, summary mathematics, summary spatial representations, or a summary of spatial features) or representations for information or data that is not presented in the in-view window. The summary strips, or the information in the summary strips, may, for example, represent, in the form of icons, glyphs, charts, or other representations, large amounts of data that is not presented in the in-view window. Information in the summary strips may also have a temporal component, for example, in the form of a glyph that flashes, moves, or changes shape or color over time. This is distinctly different from visualizations that simply provide scaled down representations of the information or data that is not presented in the in-view window (e.g., a de-magnified portion of a map). Scaled down representations are not precluded from information contained in the summary strips.

By way of example only, consider a map visualization of islands in the Pacific Ocean some of which are inhabited by turtles. For islands that are not presented in the in-view window, the summary strip could contain icons to represent one or more islands and icons to represent those islands inhabited by turtles. Information contained in the summary strips may be, for example, simpler or less than the original information (e.g., information represented by the summary strips and that is not presented in the in-view window). Metadata about the of-screen data are represented in the summary strip.

By way of example only, embodiments of the invention may be visualizations of maps, processes or data points. FIGS. 2-8 are exemplary visualizations, of maps, process charts and data points, according to embodiments of the invention.

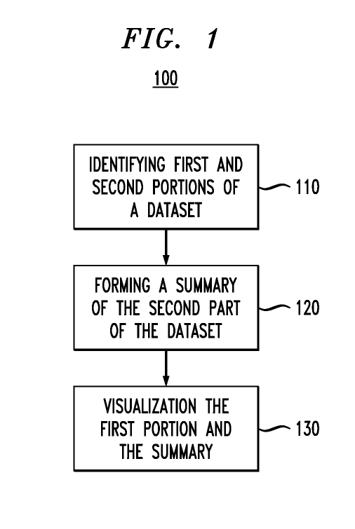

FIG. 1 is a flow diagram of a method 100 for visualizing (e.g., context visualization) a dataset, according to an embodiment of the invention. Visualization may be, for example, on a display device. The dataset may comprise or represent, for example, a spatial representation (e.g., a map or geographical information), a graph or chart (e.g., a graph comprising a plurality of data points such as a scatter plot (e.g., X-Y plot), a line graph, a bar graph, a graph illustrating one or more processes), a two-dimensional visualization, a three-dimensional visualization, a multi-dimensional visualization and/or any data for a visual representation. The dataset may be considered to comprise the data for the above examples.

Step 110 of method 100 comprises partitioning a dataset by identifying first and second portions of the dataset. The partitioning of the dataset may, for example, be considered as a partitioning of a visualization of the dataset into a first part of the visualization and a second part of the visualization. The step 110 may comprise, for example, scrolling, magnifying or de-magnifying of data within the dataset, by a user or viewer, to place a portion of the dataset into or out of view (i.e., into or out of the in-view visualization). The portion of the visualization or dataset that is placed in the in-view visualization becomes a first part of the visualization or the first portion of the dataset. The portion of the visualization or dataset that remains out of view (i.e., not within the in-view visualization) becomes a second part of the visualization or the second portion of the dataset. Thus, as a user continues to scroll or zoom in upon different data within the dataset, the first and second parts of the visualization are redefined and the first and second portions of the dataset are redefined. This redefinition of the first and second portions in response to scrolling or zooming may happen in a continuous manner or in a periodic manner. In either case, the step 110 may be repeated one or more times.

After partitioning, the dataset comprises a first portion and a second portion. The first portion and the second portion each may have respective original visualizations, each represented by an original spatial shape (i.e., a first portion original spatial shape and a second portion original spatial shape). An original visualization, as used herein, means a visualization of all of the data in the dataset, or a portion thereof, for example, a visualization before any data of the dataset is summarized or transformed to form summary information displayed in the summary strips or indicators. Thus, an original visualization of the second portion of the dataset comprises a visualization of all data in the second portion of the dataset, and/or a visualization of the second portion of the dataset before data of the second portion of the dataset is summarized or transformed to form summary information. An original spatial shape may be considered, for example, a spatial shape that renders or provides for visualization of all of the data within the associated dataset or associated portion of the dataset (e.g., the second portion). An original spatial shape may comprise additional attributes besides just an outline, physical or geometric shape. The original spatial shape may comprise, for example, attributes of color, texture, pattern, shading, transparency and size. Alphanumeric characters are considered examples of shapes.

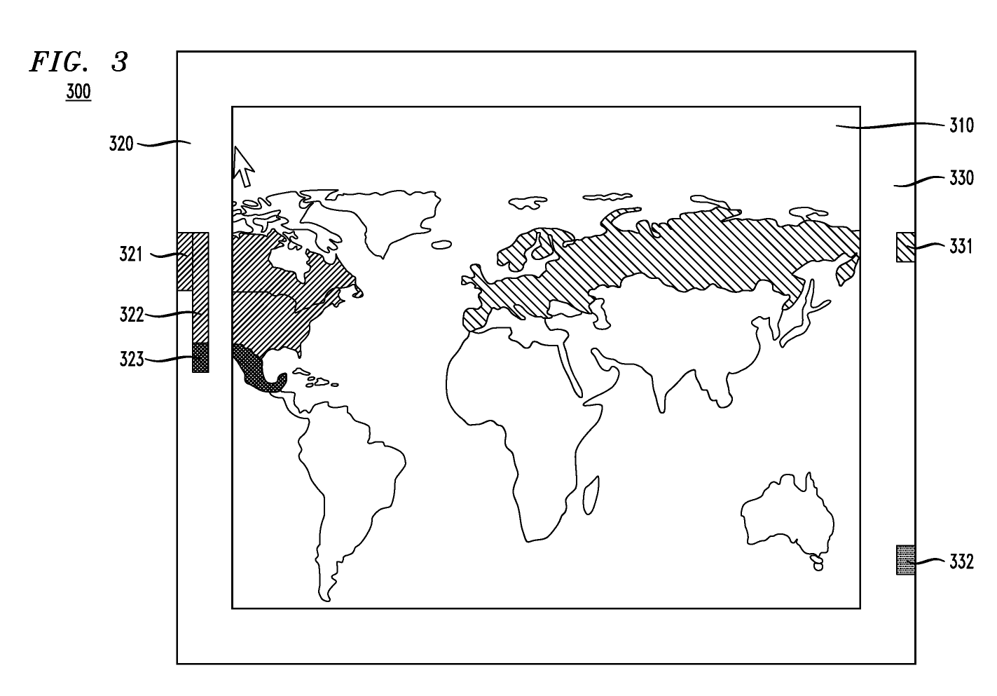

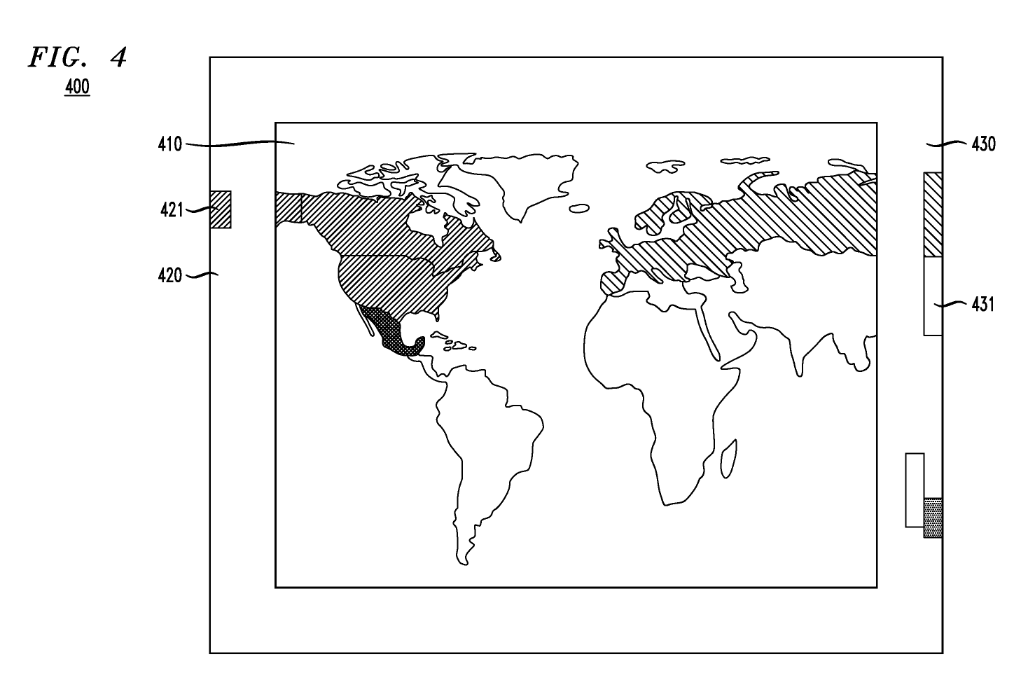

For example, the 2D map 200 is a rendered original visualization or image of both a first portion and a second portion of a dataset comprising the map 200, that is, it is a rendering of the complete dataset of the map. In FIG. 3, an in-view visualization 310 is an example of a rendering of a first portion of the dataset and an example of a rendering of a first part of the map 200. A second part of the map 200 is out of view in FIG. 3, and is represented by summary strips 320 and 330. In FIG. 4, showing another in-view visualization 410 after scrolling the in-view visualization 310, because the map has been scrolled, the dataset and the visualization 200 is divided into different first and second parts and different first and second portions. This illustrates a possible dynamic aspect of the invention, namely, that the definition of the first and second portions of the dataset or parts of the visualization can change, for example, due to scrolling or zooming in or out of representations of the dataset.

Step 120 comprises forming a summary (e.g., a visual summary) of the second portion of the dataset. The summary may be formed on or by a processor device (e.g., a processor device associated with a display device for displaying visualizations according to principles of the invention and/or a processor device coupled to a memory). By way of example only, the summary may include an abstraction of the second portion, a statistical summary of the second portion, a mathematical summary of the second portion, and a summary of spatial features of the second portion original spatial shape.

Because the summary of the second portion of the dataset may be intended to represent the second portion in a visually simplified manner (e.g., a visual representation of the summary may be visually simpler or less complex than the original visualization of the second portion) information may be lost in forming the summary. That is, an amount of information contained in the summary may be less that an amount of information contained in the second portion of the dataset.

In an embodiment of the invention, step 120 comprises forming a summary of a portion of the dataset (e.g., the second portion of the partitioned dataset) that is represented by the second part (i.e. an out of view part) of the first visualization when the second part of the first visualization is selectively moved out of view on a display device displaying the first visualization.

In an alternate embodiment of the invention, step 120 comprises forming a summary of a portion of the dataset (e.g., the first portion of the partitioned dataset) that is represented by a first part (i.e., and in-view part) of a visualization.

In another alternate embodiment of the invention, step 120 comprises forming a summary of a first portion of the dataset (e.g., the first portion of the partitioned dataset) that may, for example, be represented by a first part (i.e., the in-view part) of a visualization, and a second portion of the dataset (e.g., the second portion of the partitioned dataset) that may, for example, be represented by a second part (i.e. an out of view part) of the visualization. The summary may represent aspects of the second portion or the second part combined with aspects of the first portion or the first part, or may represent aspects of the second portion or second part and aspects of the first portion or first part.

It is to be appreciated that in an embodiment of the invention, a summary is metadata of the second portion of the dataset and/or metadata of the second part of the visualization.

By way of example only, consider map 200 shown in FIG. 2, a part of map 200 is shown as the in-view visualization 310 in FIG. 3, and the another part of map 200, that is out of view in FIG. 3 is represented by the summary strips 320 and 330 in FIG. 3. Map 200 is comprised in a dataset. A first portion of the dataset comprises a first part of map 200 that is in-view in FIG. 3, and a second portion of the dataset comprises a second part of map 200 that is out of view in FIG. 3. A summary of the part of map 200 that is out of view in FIG. 3 is formed. Features of the land of the out of view part are summarized. For example, part of the out of view part that is out of view and to the left of the in-view part includes a portion of Mexico and a portion of North America including a portion of Canada and a portion of the United States. In forming the summary, the vertical extents and positions of the out of view portion of North America (including the Canada and the United States), Canada and Mexico are calculated or extracted from the second portion of the dataset or the out of view part of map 200. The left indicators are formed as representations of the vertical extents and positions.

Step 130 comprises visualization of the first portion of the dataset and visualization of the summary of the second portion of the dataset. The visualization for example, may be on a display device. The visualization may comprise, for example, an original visualization of the first portion of the dataset. Alternately, the visualization may comprise a new visualization or a transformation of the original visualization. Transformations may include, but are not limited to, shape changes, color changes, mathematical operations, statistical operations, magnifications and demagnifications. The visualization of the first portion of the dataset may comprise, for example, rendering a display of the visualization, for example, on the display device or within a viewing or display window which may be termed an in-view window.

The visualization of the first portion of the dataset may be, for example, comprised within a first visualization of the dataset, the first visualization comprising a first part of the first visualization and at least a second part of the first visualization. According to methods of the invention, the first part is displayed in an in-view window and the second part is an out of view part summarized is a visual summary.

In the visualization of the summary, the summary is represented by one or more spatial shapes, which may be termed summary spatial shapes. For example, in FIG. 3, the spatial shapes that represent the summary include left indicators 321, 322, and 323 and right indicators 331 and 332. As can be seen in FIG. 3 these indicators are rectangular spatial shapes. In general, spatial shapes representing the summary are not limited to rectangles. Other exemplary spatial shapes that may represent the summary include one or more of a rectangle, a texture, a pattern, a color, an icon, a shading, a level of transparency, a glyph, an annulus, a circular shape, and an alpha-numeric character. A glyph is a symbol that conveys information nonverbally. For example, a glyph may represent data, a visual object or a visual shape, wherein the glyph may indicate, through the appearance of the glyph, information about the data, visual object or visual shape. By way of example only, an indicator may comprise a glyph that has a certain level of transparency indicative of the density of data points represented by the glyph.

In an embodiment of the invention, step 130 comprises presenting a second visualization of the dataset on the display device, the second visualization comprising a visual summary of the second part of the first visualization (i.e., an out of view part) in spatial coordination with the first part of the first visualization (i.e. an in-view part). The first and second visualizations are presented on a display device coupled to or associated with a processor device, for example, the processor device associated with forming the visual summary.

Because the summary spatial shapes are typically, although not necessarily, visualized in less area that an un-summarized view (e.g., an original visualization) of the second portion of the dataset or the out of view part of the original first visualization, and because the summary spatial shapes represent a summary of the second part or the out of view part, it may be typical to have summary spatial features that are simpler or less complex than more complete views (i.e., un-summarized views) of the second portion of the dataset or the out of view part of the first visualization. Thus, the visualization of the summary will be different from an un-summarized view of the second portion. That is, in the visualization of the summary, the summary is represented by one or more summary spatial shapes that are different from the second portion original spatial shape. For example, one or more spatial shapes representing the summary may have fewer spatial features that a number of spatial features in the out of view part of the first visualization or of the second portion original spatial shape. A spatial feature may be, for example, a straight line segment, a curved line segment, a bent line segment, or any geometric feature. The indicators 321, 322, 323, 331 and 332 of FIG. 3 are simpler, less complex and different than an un-summarized view of the out of view part (i.e., the second part) of map 200.

The summary spatial shapes may be visualized within an image window, a visualization areas or a display window. By way of example only, consider the summary strips 320 and 330 of FIG. 3. The left indicators 321, 322 and 323 are arranged within the left summary strip 320 and the right indicators 331 and 332 are arranged within the right summary strip 330. The left summary strip 320 and the right summary strip 330 are examples of the image windows, display windows or visualization areas for visualizing or displaying the summary spatial shapes. In this example, the visualization areas for the summary shapes (i.e., the summary strips) are adjacent to the visualization area or image window for the in-view visualization 310. For example, the visualization of the summary of the second portion of the dataset includes one or more second portion visualization areas adjacent to a first portion visualization area occupied by the visualization of the first portion of the dataset. The summary spatial shapes are visualized within the one or more second portion visualization areas.

The step 130 may, optionally, further comprise selection, by a user or viewer, of one of the one or more summary spatial shapes (e.g., indicators 321, 322, 323, 331 and 332 of FIG. 3) and visualization of data from the second portion of the dataset used to form the summary of the out of view part of the first visualization or of the second portion of the dataset. The visualization of data from the second portion is performed is accordance with, or in response to, the selection of the one of the one or more summary spatial shapes. In this way details of information contained in the summary or used to form the summary are made available to a user or viewer on demand. The user may indicate or select summary spatial shapes by a user controlled screen pointer, for example, a user controlled screen pointer comprising a mouse device.

In an embodiment of the invention, steps 120 and 130 are performed in response to the step 110, the partitioning of the dataset. If the step 110 is repeated, as may occur during scrolling or zooming in upon data of the dataset, step 120 and 130 may be repeated, reflecting a dynamic, on-the-fly, and real-time nature of the method.

FIG. 2 illustrates a 2D map 200. The map 200 is a visualization of the entire world at some level of detail. Map 200 may be comprised in a dataset and displayed on a display device.

FIG. 3 illustrates scrolled map 300 showing a part of map 200 scrolled so that the western portion of North America is not in-view (i.e., outside of an in-view visualization 310), according to an embodiment of the invention. The map may be scrolled by a user using, for example, a pointing device (e.g. a mouse device) and scroll bars associated with the in view part of the map. Scrolled map 300 is a visualization comprising the in-view visualization 310, a left summary strip 320 and a right summary strip 330. The in-view visualization 310 comprises a part of map 200. The left summary strip 330 comprises left indicators 321, 322 and 323 representing a part of map 200 that is not currently in-view but to the left of the in-view visualization 310 (i.e. out of view to the left). In this case, left indicators 321 represents that portion of Canada that is out of view to the left. Note that the color or shading of the left indicator 321 is the same color or shading as the out of view portion of Canada. Also note that the vertical extent or measure of the left indicator 321 equals the vertical measure of the out of view portion of Canada, and that the vertical position of the left indicator 321 is lined up with the out of view portion of Canada. Depending upon how far out of view to the left, left indicator 321 represents, left indicator 321 may also represent Alaska, which has the same color and shading and is also out of view to the left, but further out of view than the out of view portion of Canada. Left indicator 322 represents that portion of North America that is out of view to the left. Left indicator 322 has the same color or shading as North America and is lined up with the out of view portion of North America. Left indicator 323 represents that portion of Mexico that is out of view to the left. The Left indicator 323 has the same color or shading as Mexico and is lined up with the out of view portion of Mexico. The right summary strip 330 comprises right indicators 331 and 332 representing a part of map 200 that is out of view to the right. In this way, the left summary strip 320 and the right summary strip 330 provide information (e.g., contextual information) about map 200 that is currently out of view. The summary strips 320 and 330 may indicate the position, the land mass (e.g., the country or continent), and magnitude (e.g., size or extent of) of the out of view information. Furthermore, summary strips 320 and 330 may indicate only information that is out of view by up to a specified amount (e.g., a specified distance or number of miles). Alternately, summary strips 320 and 330 may indicate any or all information that is out of view.

FIG. 4 illustrates scrolled map 400 showing a part of map 200 scrolled so that the eastern most parts of map 200 are not in-view, according to an embodiment of the invention. Scrolled map 400 is similar to scrolled map 300. Scrolled map 400 is a visualization comprising an in-view visualization 410, a left summary strip 420 and a right summary strip 430. The in-view visualization 410 comprises a part of map 200. The left summary strip 420 comprises left indicator 421, representing a part of map 200 that is not currently in-view but to the left of the in-view visualization 410. In this case, left indicators 421 represents that portion of Alaska that is out of view to the left. The right summary strip 430 comprises right indicators, for example, right indicator 431, representing a part of map 200 that is out of view to right. As in scrolled map 300, the summary strips (e.g., 420 and 430) may indicate or represent the position, the land mass (e.g., the country or continent), and magnitude (e.g., size or extent of) of the out of view information (e.g., the out of view geography). As in FIG. 3, the indicators in the summary strips have the same color or shading as what is represented in the out of view geography, and line up with the represented out of view geography.

In the case where scrolled map 300 is displayed and subsequently scrolled to form scrolled map 400, the left summary strip and the right summary strip are updated to reflect changes in out of view and in-view information.

Other embodiments of the invention comprising datasets instantiated as maps may comprise, for example, information on population, terrain, weather, climate, topology or any other location dependent information that may be visualized on a map. The summary strips and indicators may provide summary information on the population, terrain, weather, climate, topology or any the other location dependent information. These embodiments, as well as the embodiments of FIGS. 1-8, are example embodiments of the invention. The invention, however, is not limited to such examples.

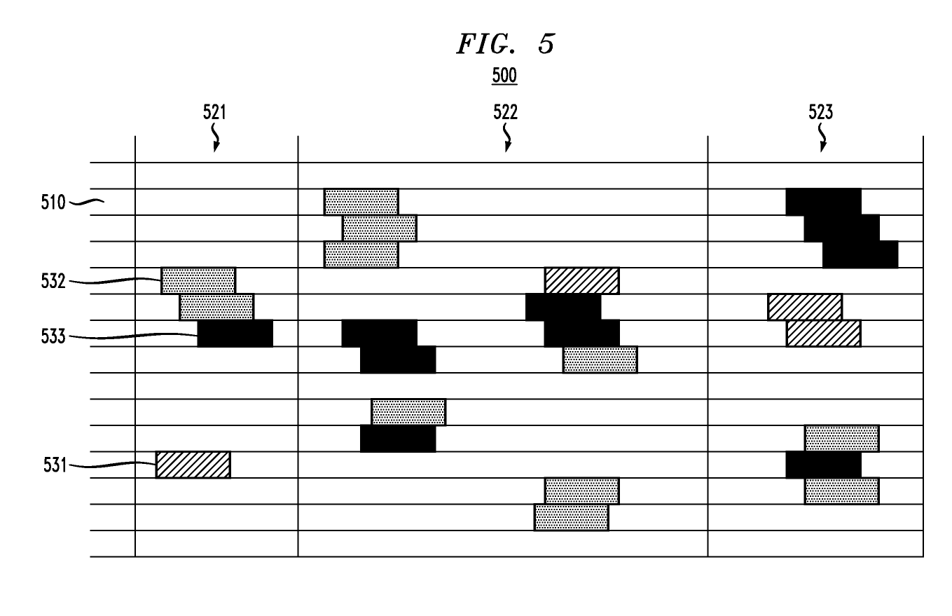

FIG. 5 shows a process flow sheet 500 for visualization of processes, according to an embodiment of the invention. The processes may be, for example, processes performed on a computing device, where processes are performed at times indicated by, or associated with, time segments, and where a process is represented by code (i.e., computer instructions) residing in address space (e.g., memory address space) of the computing device at the time of execution of the code. In this case, a process is one or more computer operations for performing a task, for example, logic or arithmetic computations, computation of a formula, updating a database, obtaining data from a data-providing device coupled to the computing device, or providing, displaying or otherwise presenting data. Performing a sequence of processes may perform a useful function, for example, monitoring seismic activity and providing warnings of possible tsunamis.

The process flow sheet 500 is divided into horizontal time segments (lines) 510, with time proceeding forward in going from one horizontal time segment to a next horizontal time segment below the one horizontal time segment. The flow sheet is further divided into first, second and third vertical segments 521, 522 and 523, respectively, representing address spaces in which the processes execute. The first, second, and third shaded or patterned rectangle 531, 532 and 533, respectively, represent event types of the processes. A dataset comprises the flow sheet 500 and/or the data contained within or represented by the flow sheet. The dataset can be segmented into a first portion and a second portion.

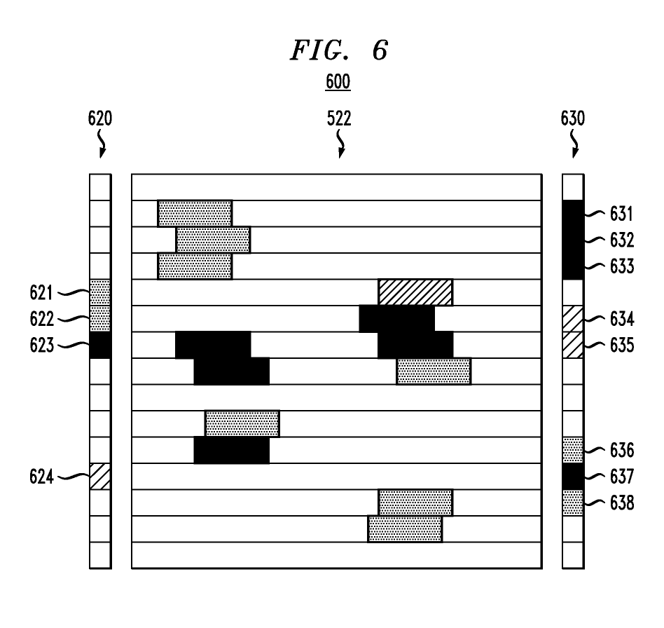

FIG. 6 illustrates a scrolled process flow sheet 600 showing a part of the process flow sheet 500 scrolled to show only the vertical segment 522, according to an embodiment of the invention. Thus, vertical segment 522 is comprised in an in-view portion (i.e., a first portion) of the dataset comprising the flow sheet 500 and/or the data contained within. A second portion of the dataset is out of view and represented by a left summary strip 620 and a right summary strip 630. Left summary strip 620 comprises left indicators 621-624, and right summary strip 630 comprises right indicators 631-638. The left indicators 621-624 indicate events that occur in the out of view vertical segment 521 visualized in FIG. 5. The right indicators 631-638 indicate events that occur in the out of view vertical segment 523 shown in FIG. 5. Note that there is a coded correspondence between the indicators 621-624 and 631-638 and the events types corresponding to rectangles 531-533. For example, right indicator 637 is shaded black to indicate or represent an event type corresponding to black shaded rectangle 533 that is in an address space represented by vertical segment 523 of FIG. 5 and occurs, in time, the fourth time slot up from the bottom. Thus, the summary strips 620 and 630 show the user the context in which this in-view visualization belongs, even while the in-view is zoomed in to focus on a single address space.

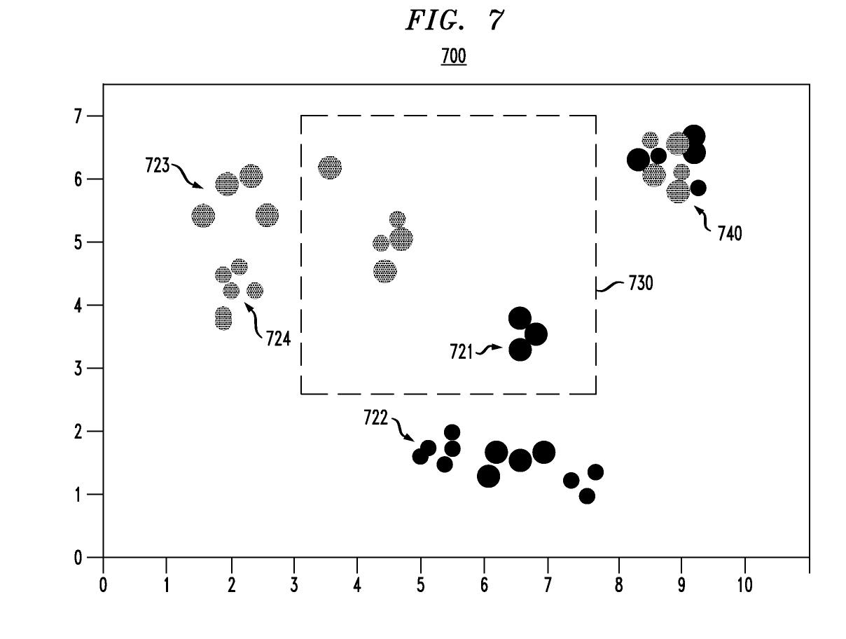

FIG. 7 illustrates a statistical scatterplot 700, according to an embodiment of the invention. Exemplary labels for the axis of scatterplot 700 may be plant height on the horizontal X axis and plant weight on the vertical Y axis. In this example, the lighter shaded (i.e., gray) data points 723 and 724 represent legume plants and darker shaded (i.e., solid black) data points 721 and 722 represent root vegetable plants. The difference in size of data points within a plant family (i.e., legume or root vegetable plants) indicates different types of plant within their respective families. For example, the smaller gray data points 724 represent bean plants and the larger gray data points 723 represent pea plants. A dataset comprises the scatterplot 700 and/or the data contained within or represented by the scatterplot 700. The dataset can be segmented into a first portion and a second portion. By way of example only, the first portion of the dataset comprises only that portion of the dataset shown within the dotted box 730, and the second portion of the dataset comprises only that portion of the dataset shown outside of the dotted box 730.

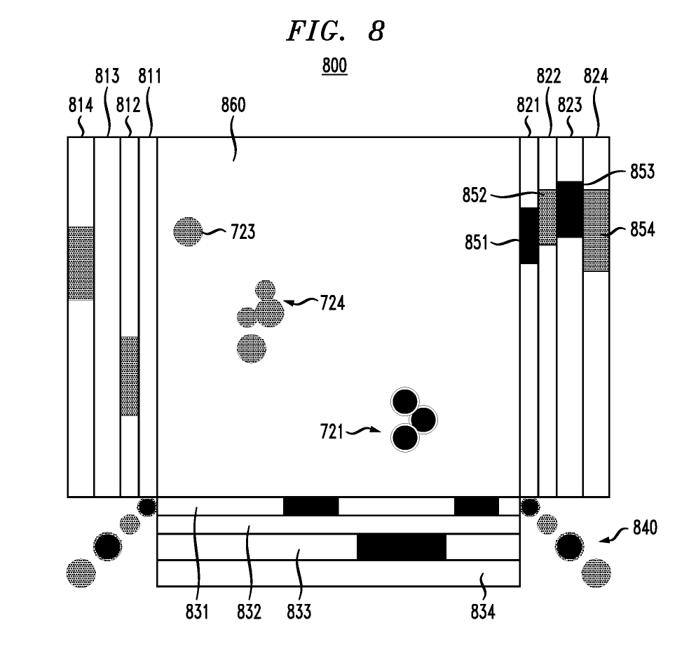

FIG. 8 illustrates a magnified part of scatterplot 700, showing a part of the scatterplot 700 magnified to show, in an in-view visualization 860 (e.g., in-view window), a portion (i.e., the first portion) of the dataset of scatterplot 700, according to an embodiment of the invention. Thus, the first portion of the dataset is an in-view portion of the dataset of scatterplot 700. The second portion of the dataset is out of view and represented by a left summary strips 811-814, right summary strips 821-824, and bottom summary strips 831-834. Consider the right summary strips 821-824. The left summary strips 811-814 and bottom summary strips 831-834 are similar to the right summary strips 821-824, although the left summary strips 811-814 and bottom summary strips 831-834 represent different out of view data. The right summary strips 821-824 represent data that is out of view to the right, that is, the cluster of data points 740 of FIG. 7. Right summary strip 821 represents the smaller black data points in the cluster of data points 740. Right summary strip 822 represents the smaller gray data points in the cluster of data points 740. Right summary strip 823 represents the larger black data points in the cluster of data points 740. Right summary strip 824 represents the larger gray data points in the cluster of data points 740. Legend 840 indicates the assignment of the various types of data points to particular summary strips. Indicator 851, visualized or shown within the right summary strip 821, represents the smaller black data points within the cluster of data points 740. Indicator 852, visualized or shown within the right summary strip 822, represents the smaller gray data points within the cluster of data points 740. Indicator 853, visualized or shown within the right summary strip 823, represents the larger black data points within the cluster of data points 740. Indicator 854, visualized or shown within the right summary strip 824, represents the larger gray data points within the cluster of data points 740. In a similar fashion the left summary strips 811-814 represent data points that are out of view to the left, and the bottom summary strips 831-834 represent data points that are out of view to the bottom.

The in-view visualization 860 may be a focused upon visualization by magnifying the first portion of the dataset, and/or the in-view visualization may be focused upon by scrolling in both the X and Y directions. The summary strips preserve the context of the in-view visualization by providing reminders about (e.g., summary information of) the structure of the data in the area that is currently out of view.

In FIGS. 3, 4, 6 and 8, the information in the summary strips has been represented as indicators comprising solid rectangles. Other embodiments of the invention provide indicators comprising one or more of shape, transparency, texture, color and/or shading. In general, characteristics of the representation in the summary strips could be of different forms to represent different characteristics of the second portion of the dataset (e.g., glyphs). For example, edges could be rounded, transparency could be varied to indicate density or uncertainty, and the scale of glyphs could be stretched or shrunken to indicate importance. Inside the summary strip, the indicators can be rendered based on: position, a histogram summarizing certain features of the out of view data elements or other abstractions based on the out of view dataset or on features of the out of view dataset. The abstractions may include, for example, a statistical summary or a mathematical summary. The indicators may, for example, represent the magnitude, position, color or other dimension of the second portion of the dataset. Furthermore, the indicators may have a temporal aspect, that is, the indicators may change over time. For example, the indicators may flash, change in color, shape or other aspect of appearance. For example, an indicator may be an icon that changes over time.

Within the summary strip, a mouse over or tool tip may be used to reveal, to users or viewers, associated information of the second portion of the dataset. Raw, aggregate, summary, transformed or compressed information from the second portion of the dataset may be provided or shown in response to the request (e.g., mouse over) by the user or viewer. Statistics or computations (e.g., mathematical operations or transformations) of the second portion of the dataset may be provided. The provided information may be according to not only the second portion of the dataset, but additionally, according to the first portion of the data set. By way of example only, consider FIG. 3, where the left indicators 321-323 and the right indicators 331 and 332 may indicate countries or portions of countries. The information provided in response to a mouse over of one of the indicators may be the country or countries that the indicator represents. By way of another example, consider the scatterplot of FIG. 8. The mean and standard deviation of the data points represented by indicators within the summary strip could be visualized or shown. As a final example, consider the process flow sheet of FIG. 6. The priority of a process event, the step, the process, or event or step name could be provided in response to a mouse over of an indicator in a summary strip.

The examples presented in FIGS. 2-8 illustrate embodiments of the invention for geographic maps, process visualization, and scatterplots. The concept of the invention can be extended to other forms of visual information, such as organization charts, network diagrams, architectural layouts, and design visualizations. Thus, a dataset may represented by, for example, a spatial representation, a map, geographical information, a graph, a graph of one or more processes, a graph comprising a plurality of data points, a two-dimensional visualization, a multi-dimensional visualization, an organization chart, a network diagram, an architectural layout, a design visualization, or other visual representation.

A feature of the invention is that information in the summary strips may be updated dynamically as the user explores the data, e.g., as the user zooms in or scrolls upon the dataset.

One or more summary strips may be drawn on any side of in-view visualization.

One or more summary strips may be drawn on the left, to the right, to the bottom and/or to the top of the in-view visualization. Other configurations are contemplated, for example, summary data may be visualized in an area placed within or in the interior of an in-view visualization. Summary data may be visualized or shown in shapes other than strips, for example, squares, rectangles, circles or other geometric shapes.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1-8, which include a flow diagram or flowchart of the method 100, the flowchart and diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-8, can also include, as described herein, providing a system, wherein the system includes distinct modules (e.g., modules comprising software, hardware or software and hardware). By way of example only, the modules may include: a visualization module configured to visualize, on a display device, the first portion of the dataset and the summary of the second portion of the dataset, according to methods of the invention; a summary forming module configured to form a summary of the second portion of the dataset, according to methods of the invention; an identifying module configured to identify or partition a first portion and at least a second portion of the dataset, for example, according to the step 110 of method 100. These and other modules may be configured, for example, to perform the steps of method 100 illustrated in FIG. 1.

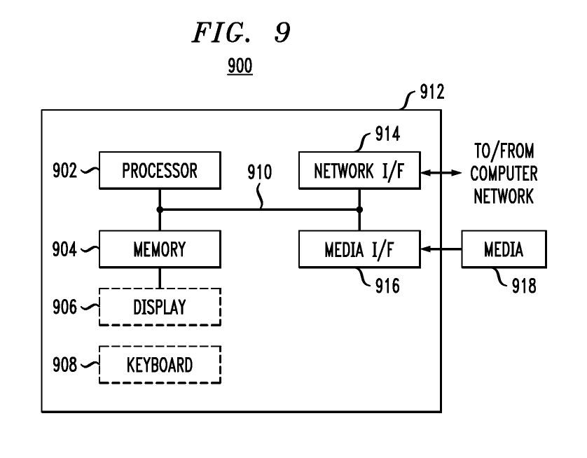

One or more embodiments can make use of software running on a general purpose computer or workstation. With reference to FIG. 9, such an implementation employs, for example, a processor 902, a memory 904, and an input/output interface formed, for example, by a display 906 and a keyboard 908. The tet “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer). The processor 902, memory 904, and input/output interface such as display 906 and keyboard 908 can be interconnected, for example, via bus 910 as part of a data processing unit 912. Suitable interconnections, for example, via bus 910, can also be provided to a network interface 914, such as a network card, which can be provided to interface with a computer network, and to a media interface 916, such as a diskette or CD-ROM drive, which can be provided to interface with media 918.

A data processing system suitable for storing and/or executing program code can include at least one processor 902 coupled directly or indirectly to memory elements 904 through a system bus 910. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 908, display 906, pointing device, and the like) can be coupled to the system either directly (such as via bus 910) or through intervening I/O controllers (omitted for clarity).

Network adapters such as network interface 914 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 912 as shown in FIG. 9) running a server program. It will be understood that such a physical server may or may not include a display and keyboard.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for visualizing a dataset, the method comprising:
identifying a first portion and at least a second portion of the dataset;
forming a summary of the second portion of the dataset; and
visualizing, on a display device, the first portion of the dataset and the summary of the second portion of the dataset;
wherein the summary is represented by one or more spatial shapes different from a spatial shape representative of the second portion before the formation of the summary; and
wherein the identification of the first portion and the second portion, the formation of the summary, and the visualization of the first portion and the summary are implemented in accordance with a processor device associated with the display device.

2. The method of claim 1, wherein identifying the first portion and the second portion of the dataset comprises:
presenting an initial visualization of the dataset on the display device; and
allowing selection of a first part of the initial visualization, wherein the first portion of the dataset corresponds to the first part of the initial visualization, and wherein the second portion of the dataset corresponds to at least part of the dataset other than the first portion of the dataset.

3. The method of claim 2, wherein formation of the summary occurs when a second part of the initial visualization corresponding to the second portion of the dataset is selectively moved out of view on the display device.

4. The method of claim 2, wherein allowing for selection of the first part of the initial visualization comprises allowing at least one of: scrolling, magnification and demagnification of the initial visualization.

5. The method of claim 1, wherein the dataset is represented by at least one of: a spatial representation, a map, geographical information, a graph, a graph of one or more processes, a graph comprising a plurality of data points, a two-dimensional visualization, a three-dimensional visualization, a multi-dimensional visualization, an organization chart, a network diagram, an architectural layout, a design visualization, and a visual representation.

6. The method of claim 1, wherein the summary comprises at least one of: an abstraction of the second portion, a statistical summary of the second portion, a mathematical summary of the second portion, a histogram representative of the second portion, an indicator of position of at least one spatial feature of the second portion, and a summary of spatial features of the spatial shape representative of the second portion before the formation of the summary.

7. The method of claim 1, wherein an amount of information contained in the summary is less than an amount of information contained in the second portion of the dataset.

8. The method of claim 1, wherein the one or more spatial shapes have fewer spatial features than a number of spatial features of the spatial shape representative of the second portion before the formation of the summary, wherein a straight line segment, a curved line segment, and a bent line segment are spatial features.

9. The method of claim 1, wherein the one or more spatial shapes comprise at least one of: a shape, a shape comprising a physical dimension according to a spatial shape representative of the second portion before the formation of the summary, a shape having a position according to a position of a spatial shape representative of the second portion before the formation of the summary, a rectangle, an annulus, a circular shape, a texture, a pattern, a color, an icon, a shading, a level of transparency, a glyph, an alpha-numeric character, and an icon that changes over time.

10. The method of claim 1, wherein the visualization of the first portion and the summary comprises the summary displayed in one or more summary visualization areas adjacent to a first portion visualization area.

11. The method of claim 1, wherein the one or more spatial shapes are different from a spatial shape representative of the second portion before the formation of the summary.

12. The method of claim 1 further comprising:
selecting one of the one or more spatial shapes, and
presenting data from the second portion of the dataset used to form the summary;
wherein the presenting of the data is performed in accordance with the selection of the one of the one or more spatial shapes.

13. The method of claim 12, wherein the selection of the one of the one or more spatial shapes comprises indicating the one of the one or more spatial shapes by a user controlled screen pointer.

14. The method of claim 12, wherein the presentation of the data provides at least one of: statistical information associated with the data, mathematical information associated with the data, and a transformation of the data.

15. The method of claim 12, wherein the summary further summarizes at least part of the first portion of the dataset.

16. The method of claim 1, wherein the summary is visualized in spatial coordination with the first portion of the dataset.

17. The method of claim 1, wherein the summary comprises a context of the first portion.

18. Apparatus for visualizing a dataset, the apparatus comprising:
a memory; and
a processor coupled to the memory and configured to:
identify a first portion and at least a second portion of the dataset;
form a summary of the second portion of the dataset; and
visualize, on a display device, the first portion of the dataset and the summary of the second portion of the dataset;
wherein the summary is represented by one or more spatial shapes different from a spatial shape representative of the second portion before the formation of the summary.

19. The apparatus of claim 18, wherein identifying the first portion and the second portion of the dataset comprises:
presenting an initial visualization of the dataset on the display device; and
allowing selection of a first part of the initial visualization, wherein the first portion of the dataset corresponds to the first part of the initial visualization, and wherein the second portion of the dataset corresponds to at least part of the dataset other than the first portion of the dataset.

20. The apparatus of claim 19, wherein formation of the summary occurs when a second part of the initial visualization corresponding to the second portion of the dataset is selectively moved out of view on the display device.

21. The apparatus of claim 18, wherein the summary comprises at least one of: an abstraction of the second portion, a statistical summary of the second portion, a mathematical summary of the second portion, a histogram representative of the second portion, an indicator of position of at least one spatial feature of the second portion, and a summary of spatial features of the spatial shape representative of the second portion before the formation of the summary.

22. The apparatus of claim 18, wherein an amount of information contained in the summary is less than an amount of information contained in the second portion of the dataset.

23. The apparatus of claim 18, wherein the processor coupled to the memory is further configured to:
select one of the one or more spatial shapes, and
present data from the second portion of the dataset used to form the summary;
wherein the presenting of the data is performed in accordance with the selection of the one of the one or more spatial shapes.

24. A system for visualizing a dataset, the system comprising:
an identifying module configured to identify a first portion and at least a second portion of the dataset;
a summary forming module configured to form a summary of the second portion of the dataset; and
a visualization module configured to visualize, on a display device, the first portion of the dataset and the summary of the second portion of the dataset;
wherein the summary is represented by one or more spatial shapes different from a spatial shape representative of the second portion before the formation of the summary; and
wherein the identification of the first portion and the second portion, the formation of the summary, and the visualization of the first portion and the summary are implemented in accordance with a processor device associated with the display device.

25. An article of manufacture for visualizing a dataset, the article of manufacture tangibly embodying a computer readable program code which, when executed, causes the computer to carry out:
identifying a first portion and at least a second portion of the dataset;
forming a summary of the second portion of the dataset; and
visualizing, on a display device, the first portion of the dataset and the summary of the second portion of the dataset;
wherein the summary is represented by one or more spatial shapes different from a spatial shape representative of the second portion before the formation of the summary; and
wherein the identification of the first portion and the second portion, the formation of the summary, and the visualization of the first portion and the summary are implemented in accordance with a processor device associated with the display device.
